(19) United States
(12) Patent Application Publication
(10) Pub. No.: US 2004/0001448 A1
(43) Pub. Date: Jan. 1, 2004

(54) System and method for transmitting highly correlated preambles in QAM constellations

(76) Inventors: Shawn E. Preston, Bellevue, WA (US); Guy Lopez, Seattle, WA (US); David C. Schafer, Bellevue, WA (US)

Correspondence Address: Mark C. Comtois, Suite 700, 1667 K Street, N.W., Washington, DC, 20006, US

(21) Appl. No.: 10/183,384

(22) Filed: Jun. 28, 2002

(51) Int. Cl. H04J 3/00

(52) U.S. Cl. 370/280; 370/318; 370/336; 455/522

(57) ABSTRACT

A method for transmitting a data signal where the data signal includes a preamble portion preceding a payload portion that reduces harmonic spikes is presented. The method reduces the transmission power for portions of bursty data signal that contain highly correlated or repetitive preamble sequences relative to the transmission power that contain non-highly correlated or repetitive payload sequences. The resultant average output power of the preamble sequences is approximately equal to the average output power of the payload sequences.

### RELATED APPLICATIONS

The present application is related to commonly assigned U.S. Pat. No. 6,016,313 entitled “System and Method for broadband millimeter wave data communication” issued Jan. 18, 2000 and currently undergoing two re-examinations under application Ser. No. 90/005,726 and application Ser. No. 90/005,974 which are hereby incorporated herein by reference.

### BACKGROUND OF INVENTION

The use of highly correlated or repetitive preamble sequences is important for rapid carrier recovery, symbol timing recovery and equalization in burst mode modems. Unfortunately correlated or repetitive preamble sequences can produce undesirable spectral components at discrete locations that can exceed allowable spectral masks, which are based on the expectations of randomized sequences and averaged power level for the payload.

Some art solutions have been directed towards random preambles, phase map recovery processes, reducing preamble length much less that payload length and reducing output power.

Random preambles require increasing the length of the preamble. Furthermore symbol timing is not as robust thus symbol timing recovery takes longer.

A prior art method relies on quadrate mode slicing of a multilevel QAM constellation for carrier recovery process during the preamble, which requires only that symbols be located along the diagonal axis of the QAM constellation for proper carrier recovery. Quadrant mode slicing measures phase of the received signal relative to the diagonal of 4 quadrants and assumes received signal should be on the closest diagonal. Quadrant slicing partitions the constellation into 4 quadrants and if the received signal lands in a quadrant, the system assumes it in on the diagonal for that quadrant. This method disregards amplitude information from the signal.

Another method phase map slicing, requires symbols to be located at a valid constellation point. In phase map slicing the system determines which constellation point a received signal is closest to by comparing phase and amplitude of the received signal with the phase and amplitude of the constellation points. With phase map recovery processes, the preamble is restricted to valid symbol and the signal could still exceed the spectral mask.

Although lowering the output power of the entire signal can maintain the spikes below the spectral mask, it is an inefficient use of power spectrum capability.

Therefore, there is a need for a method of reducing spikes due to harmonics of preamble spikes while retaining the ability for rapid carrier recovery, symbol timing recovery and equalization in burst mode modems.

An object of the present invention is an improvement of a method in a communication system for transmitting a data signal. The data signal includes a preamble portion preceding a payload portion. The improvement involving decreasing the output power of the transmitter when transmitting the preamble portion.

Another object of the present invention is an improvement of a method in a communication system for transmitting highly correlated or repetitive symbols and not highly correlated symbols in an average power-limited environment. The improvement involving decreasing the output power of the transmitter when transmitting the highly correlated symbols relative to the output power of the transmitter when transmitting the non-highly correlated symbols.

Yet another object of the present invention is an improvement of a method for reducing out-of-bandwidth harmonic spikes during transmission caused by a sequence of highly correlated symbols common in a preamble portion of bursty type data. The improvement involving transmitting the highly correlated symbols at a lower transmitter power than when transmitting non-highly correlated symbols common in a payload portion of bursty type data.

Still another object of the present invention is an improvement for a method of transmitting frames of data, where the frames of data include a preamble and payload portion. The improvement involving ensuring the average power of the transmitted signal representing the preamble is less than or equal to the average power of the transmitted signal representing the payload portion.

These and many other objects and advantages of the present invention will be readily apparent to one skilled in the art to which the invention pertains from a perusal of the claims, the appended drawings, and the following detailed description.

### BRIEF DESCRIPTION OF THE DRAWINGS

FIG. 1 is a graph of signal power and spectral mask in the frequency domain.

FIGS. 2A and 2B are graphs of signal amplitude for the payload and preamble portions in the time domain.

FIG. 3 is a representation of a QAM constellation with average signal power rings.

FIG. 4 is a graphical representation of peak signal amplitude for the payload and preamble portions in the time domain according to the present invention.

### DETAILED DESCRIPTION

Data signals used in bursty type data transmission commonly contain a preamble portion and a payload portion. The preamble portion commonly contains sequences of highly correlated and or repetitive symbols. Preamble sequences, especially when transmitted in short bursts, introduce harmonic spikes into the signal, which often exceed the allowable spectral power constraints.

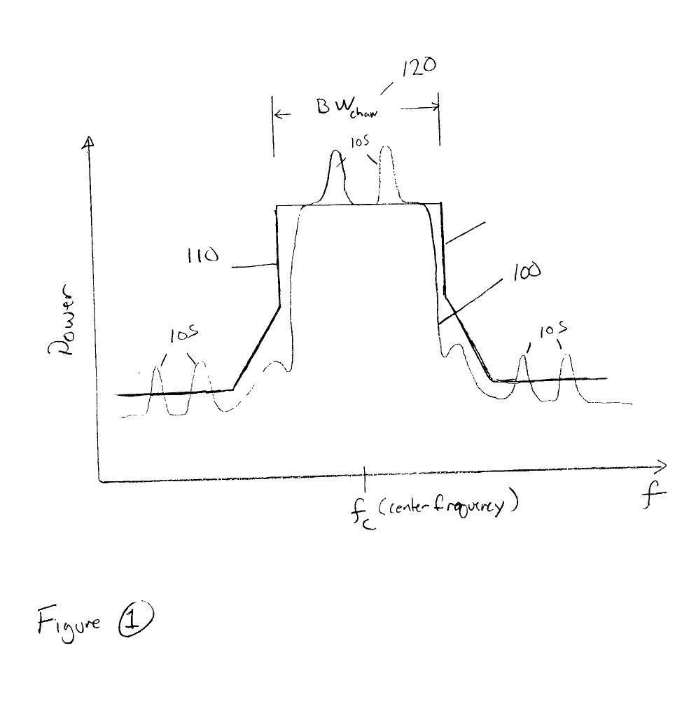

FIG. 1 shows a representation of the power of a bursty data signal 100 in the frequency domain. A spectral mask 110 defines the permissible signal power for a range of frequencies. The maximum signal power allowed is centered on the center frequency, and spans the channel bandwidth 120 before tapering off on both sides of the channel bandwidth 120. The data signal 100 contains spikes 105 that exceed the spectral mask 110 and thus the permissible limits. These spikes are predominately caused by the harmonics of the preamble portion of the data signal.

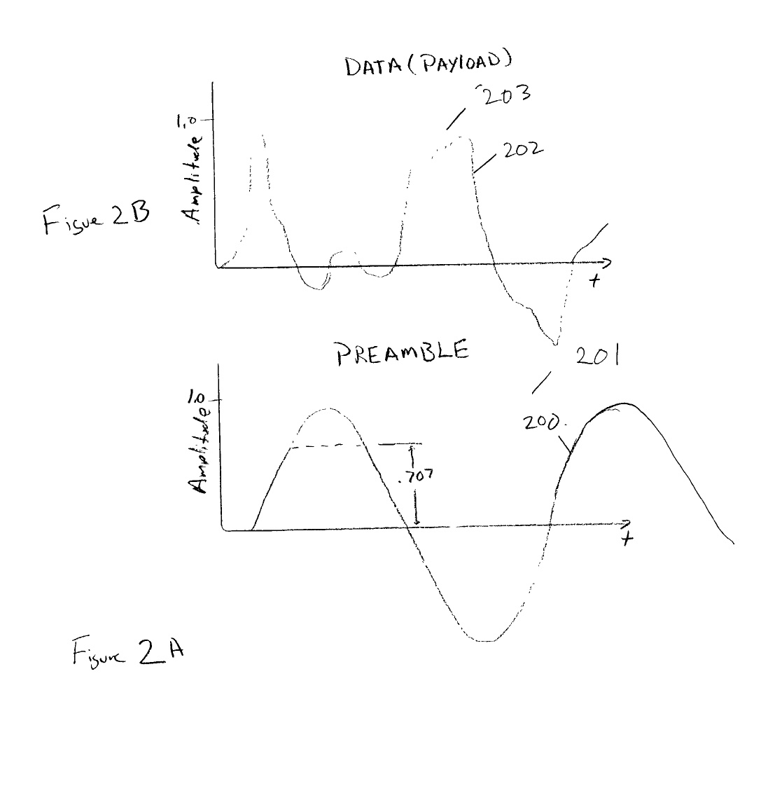

FIG. 2A is a graphical representation of the amplitude of the symbol stream 200 of the preamble portion 201 of the data signal with respect to time. Because the length of the block of preamble symbols is short and generally restricted to 4 Quadrature Amplitude Modulation (QAM), the preamble symbol stream 200 acts similar to a sine wave. Thus modeling the preamble symbol stream 200 as a sine wave, the preamble portion of the signal has an average amplitude of 0.707 of the peak amplitude and peak power to average power (Pₚₖ/P_{avg}) approximately equal to 3 dB.

FIG. 2B is a graphical representation of the amplitude of the symbol stream 202 of the payload portion 203 of the data signal with respect to time. As seen from FIG. 2A the payload portion of the signal appears random. This randomness is common in payload portions for several reasons. First, the symbols in the payload portion represent the useful data in the data signal as such variation between successive symbols in likely. Also the payload section in order to contain as much information as possible can have higher signal densities or (QAM) levels higher than the 4 QAM typical of preamble portions. The length of the block of data symbols transmitted by the payload portion is also much longer than those of the preamble. Thus, the data symbol stream 202 of the payload portion 203 acts more random than does the preamble section. The result of the random nature, the payload portion 203 has a peak power to average power (Pₚₖ/P_{avg}) approximately equal to 12 dB.

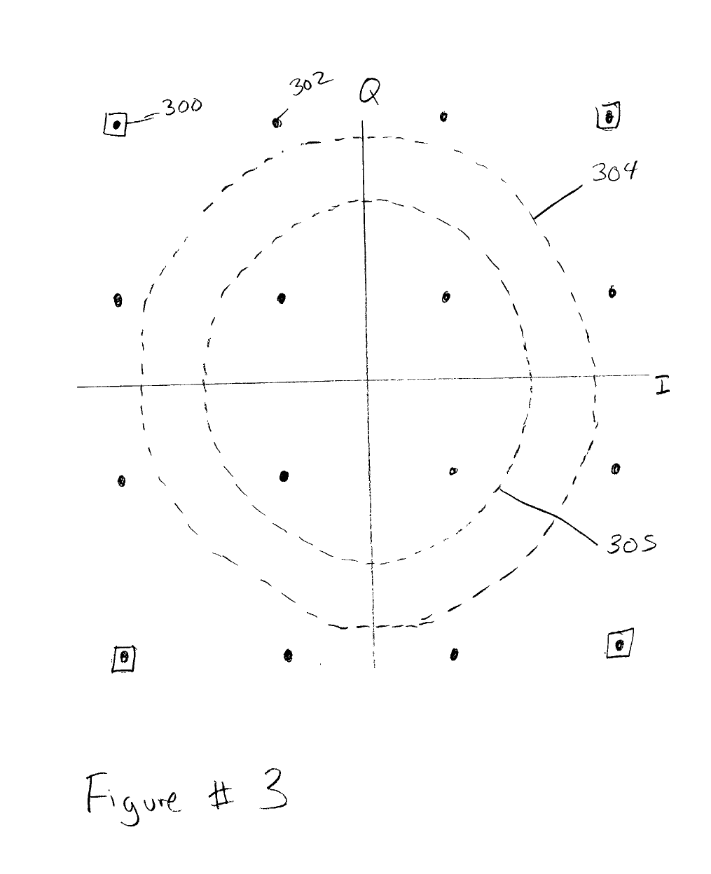

A representation of the QAM constellation is shown in FIG. 3. The valid payload data symbols 302 are shown as points. As discussed previously the payload data is not limited in QAM level. The valid preamble data symbols 300 are shown as squares, again the preamble is generally limited to 4 QAM. The preamble symbol average output power band is shown as circle 304 while the payload symbol average output power P_{avg/payload} band is shown as circle 305. From FIG. 3 it is clear that P_{avg/preamble} is much greater than P_{avg/payload}.

Given this disparity in relative average power, it is possible to reduce P_{avg/preamble} down to or below P_{avg/payload} by reducing the power at which the preamble symbol stream is transmitted relative to the power at which reducing the power at which the preamble symbol stream is transmitted relative to the power at which transmits at the payload symbol stream. As a result the peak amplitude of the preamble symbol stream is reduced. The reduction of the preamble peak amplitude can reduce the magnitude of the harmonic spikes 105 to below the spectral power mask 110.

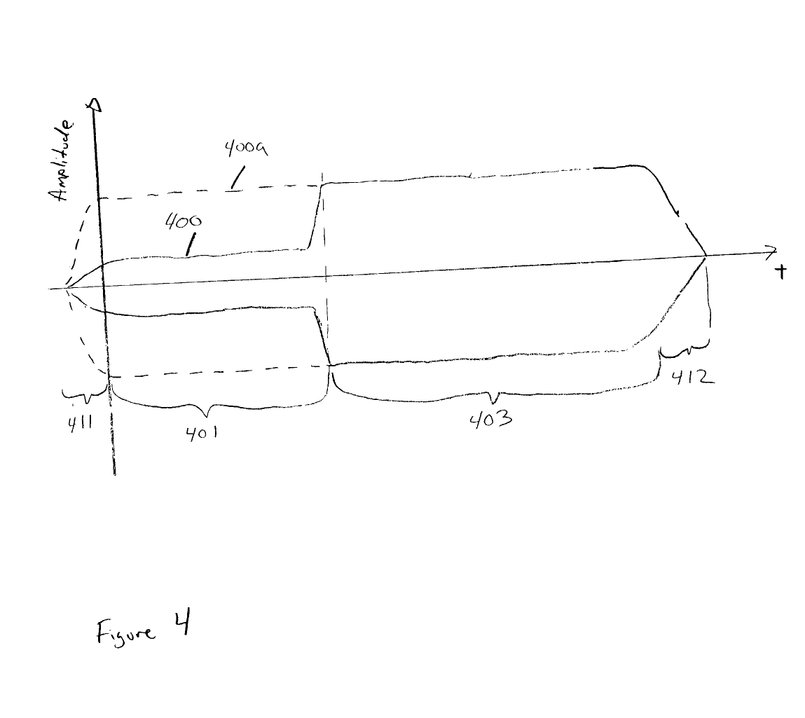

A signal transmitted with a reduced power setting for the preamble portion compared to the payload portion is shown in FIG. 4. The signal's 400 transmit power and correspondingly its amplitude is increased the ramp up portion 411 until it reaches the transmit power and maximum amplitude of the preamble portion 401. The signal's 400 transmit power is again increased up to the transmit power and maximum amplitude of the payload portion 403. The transmit power is then ramped down 412 after transmission of the payload portion. In contrast the signal 400a is shown where the transmit power is not reduced for the preamble portion 401.

The transmit power of the preamble is preferably reduced such P_{avg/preamble} is approximately equal to P_{avg/payload}. The desired bandwidth of the preamble output power band (i.e. the diameter of the power band 304 shown in FIG. 3), and thus the preamble transmit power setting, is determine from several factors, most dealing with the determination of P_{avg/preamble}. Among these factors are spectral mask type, bandwidth and filter for spectral mask, payload length relative to preamble length, modulation index, desired c/n in control channel and preamble pattern.

The characteristics of the spectral mask are necessarily a component in determining the desired preamble power bandwidth in that reducing the transmit power of the preamble is done to prevent the harmonic spike from exceeding the mask. The greater the relative length of the payload portion to the preamble portion allows the desired preamble power bandwidth to increase as does a more random preamble pattern. The modulation index of the payload portion has an inverse effect, the higher the modulation index of the payload portion compared to the preamble portion, the narrower the desired preamble power band becomes.

All of some of these factors and other may be evaluated prior to transmission of the signal in order to determine the desired preamble power bandwidth, the estimated Pₚₖ/P_{avg} and thus the desired transmit power reduction for the preamble portion of the signal.

Transmit preamble power control as describe above can be advantageously used in communication system employing bursty type data messages, such as Time Division Duplex (TDD) and Adaptive Time Division Duplex ATDD.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. The present invention is not intended to be limited to the embodiments shown herein but is to be accorded the widest scope consistent with the principles and novel features disclosed herein.

We claim:

1. In a communication system, a method for transmitting a data signal where the data signal includes a preamble portion preceding a payload portion, the improvement comprising decreasing the output power of the transmitter when transmitting the preamble portion.

2. The method of claim 1, wherein the average output power of the transmitter when transmitting the preamble is equal to or less than the average output power of the transmitter when transmitting the payload portion.

3. The method of claim 2 where system is TDD

4. The method of claim 3, wherein the system is adaptive

5. The method of claim 4, wherein the system is for broadband short distance radio communication of bursty data between one computer network to another computer network.

6. The method of claim 2, wherein the average power of the payload portion is estimated prior to transmission

7. The method of claim 2, wherein the average power of the preamble portion is estimated prior to transmission.

8. The method of claim 7, wherein the average power of the preamble is estimated as a sine wave

9. In a communication system, a method for transmitting highly correlated or repetitive symbols and non highly correlated symbols in an average power-limited environment, the improvement of decreasing the output power of the transmitter when transmitting the highly correlated symbols relative to the output power of the transmitter when transmitting the non highly correlated symbols.

10. The method of claim 9, wherein the average output power of the transmitter when transmitting the highly correlated symbols is equal to or less than the average output power of the transmitter when transmitting the non-highly correlated symbols.

11. The method of claim 10 where system is TDD

12. The method of claim 11, wherein the system is adaptive

13. The method of claim 12, wherein the system is for broadband short distance radio communication of bursty data between one computer network to another computer network.

14. The method of claim 10, wherein the average power of the payload portion is estimated prior to transmission

15. The method of claim 10, wherein the average power of the preamble portion is estimated prior to transmission.

16. The method of claim 15, wherein the average power of the preamble is estimated as a sine wave

17. In a method for reducing out of bandwidth harmonic spikes during transmission caused by a sequence of highly correlated symbols common in a preamble portion of bursty type data, the improvement comprising transmitting the highly correlated symbols at a lower transmitter power than when transmitting the non-highly correlated symbols common in a payload portion.

18. The method of claim 17, wherein the average output power of the transmitter when transmitting the highly correlated symbols is equal to or less than the average output power of the transmitter when transmitting the non highly correlated symbols.

19. The method of claim 18, wherein the average power of the non-highly correlated symbols is estimated prior to transmission

20. The method of claim 18, wherein the average power of the sequence of highly correlated symbols is estimated prior to transmission.

21. The method of claim 20, wherein the average power of the sequence of highly correlated symbols is estimated as a sine wave

22. A method of transmitting frames of data, where the frames of data include a preamble and a payload portion, the improvement wherein the average power of the transmitted signal representing the preamble is less than or equal to the average power of the transmitted signal representing the payload portion.

23. The method of claim 22, where the preamble portion comprises highly correlated or repetitive symbols.

24. The method of claim 23, wherein the average power of the payload portion is estimated prior to transmission

25. The method of claim 23, wherein the average power of the preamble portion is estimated prior to transmission.

26. The method of claim 25, wherein the average power of the preamble portion is estimated as a sine wave

27. The method of claim 23, wherein the frames of data include a ramp up portion between the preamble and the payload portions.

28. The method of claim 27, wherein the frames of data include another ramp up portion prior to the preamble portion.

29. The method of claim 22 wherein the preamble portion is transmitted at 4 QAM

30. The method of claim 29, wherein the payload portions is transmitted at 4 QAM or higher.

31. The method of claim 30, wherein the payload portion and preamble portions are transmitted at different QAM rates.
